(19) United States
(12) Patent Application Publication
(10) Pub. No.: US 2014/0279041 A1
(43) Pub. Date: Sep. 18, 2014

(54) SYSTEM AND METHOD FOR PAYMENT ACCOUNT FEE PREVENTION

(71) Applicants: Thomas M. Isaacson, Huntingtown, MD (US); Joseph Bous, Washington, DC (US)

(72) Inventors: Thomas M. Isaacson, Huntingtown, MD (US); Joseph Bous, Washington, DC (US)

(21) Appl. No.: 13/835,656

(22) Filed: Mar. 15, 2013

Related U.S. Application Data
(60) Provisional application No. 61/777,718, filed on Mar. 12, 2013.

(51) Int. Cl. G06Q 20/24

(52) U.S. Cl. CPC G06Q 20/24
USPC 705/14.66; 705/39

(57) ABSTRACT

Disclosed herein are systems, methods, and non-transitory computer-readable storage media for payment account fee prevention. A system monitors purchases made by a payment account, the account having a penalty fee that is applied due to purchase inactivity during a period of time and withdraws an amount of money from the payment account prior to the end of the period of time when the system indicates purchase inactivity to avoid the penalty fee application. The amount of money is calculated as a percentage of the penalty fee, such that a user is charged a lesser fee by the system than an entity collecting the penalty fee for account inactivity. In one embodiment, the system presents an interactive notice with an optional product advertisement, as a reminder to the user via a device, enabling a payment to an entity prior to the end of the period of time.

### PRIORITY INFORMATION

The present application claims priority to Provisional Application No. 61/777,718, filed Mar. 12, 2013, the content of which is incorporated herein by reference in its entirety.

### BACKGROUND

1. Technical Field

The present disclosure relates to purchases completed using a payment account and more specifically to preventing fee charges relating to an idle payment account.

2. Introduction

Banks and other entities make money by loaning money and charging fees for services. Examples of service fees charged by banks are account maintenance fees, ATM fees, penalty charges, commissions and application fees. Banks charge penalties for low account balances, late payments and exceeding transaction limits, for example. Other entities such as credit card and utility companies charge late fees when payments are not received by the due date. Basically, the entities will consider non-activity on accounts as a negative feature of the account and after a period of time of non-activity, a fee will be charged to the account. Often, an entity will issue a due date for payment and allow a grace period after the due date for a customer to make a payment. Online stores can establish user payment accounts that are charged fees when users do not use their accounts on a regular basis. Users having payment accounts with entities that charge fees can easily become overwhelmed with keeping track of payment due dates, and can unintentionally receive fee charges for idle payment accounts or late payments.

In addition, some services do not allow an auto-debit approach because they have an intention of making people pay late and thus make extra money on the fees. These approaches make it more difficult for the owner of a payment account to avoid paying fees like the fees discussed above.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for payment account fee prevention. A system performing payment account fee prevention monitors purchases made by a payment account related to a user, the account having a penalty fee that is applied due to purchase inactivity during a period of time, to yield an analysis. When the analysis indicates purchase account inactivity near the end of the period of time, the system withdraws an amount of money from the payment account prior to the end of the period of time. An example of “near” the end of the payment period is 1-4 days. Shorter and longer periods of time are contemplated but the context of the definition of “near” applies—which is typically a monthly payment cycle. But under a different payment cycle, the concept of “near” the end could vary. For example, “near” the end of a two-week payment cycle can be 1-2 days whereas being “near” the end of a one month payment cycle might be 1-4 days. The person's prior payment history can also have a bearing on when the time is “near” the end. For example, if the user usually pays on the last day of the payment cycle, in the afternoon, “near” the end of the payment cycle might mean 6 hours. The system withdraws the amount of money from the payment account to prevent an application of a penalty fee; the withdrawal is associated with a purchase using the payment account. For example, when a user does not use their online payment account associated with an online store in a 30 day period, the store issues a $3 fee. The system can withdraw an amount of money related to the payment account such that the online store does not issue a penalty fee, such as $1.50. When the system withdraws the amount of money prior to the end of the period of time and a user completes a purchase using the payment account prior to the end of the period of time, the amount of money is refunded to the payment account. The amount of money withdrawn by the system can be calculated as a percentage of the penalty fee, or a fixed amount. Optionally, the penalty fee amount is monitored and the amount of money is calculated based on the penalty fee. For example, when the penalty fee increases from $9.95 to $10.06, the amount of money withdrawn automatically increases in relation to the penalty fee.

In one embodiment, a user of the payment account is presented one or more advertisements on a user device such as a smartphone or tablet that is based on payment account purchase inactivity and the end of the time period such that when the user makes a purchase based on the advertisement, the amount of money is withdrawn from the payment account and a product associated with the advertisement is delivered to the user. The advertisement can be selected based on the penalty fee and/or the type of payment account. For example, a user having a credit card payment account that is about to have a fee applied due to account inactivity is presented with an advertisement for a product costing less than the amount of the penalty fee. Alternately, the product can cost more than the amount of the penalty fee based on previous user purchases or user preferences.

In another embodiment, the system monitors purchases made by a payment account of the user to determine whether a payment has been made during a period of time to an entity, the payment being associated with a periodic payment schedule to yield an analysis. When the analysis indicates a penalty fee application to the payment account due to payment account purchase inactivity near an end of the period of time, the system performs one or both of presenting an interactive notice and automatically enabling the payment. The interactive notice is presented to the user via a user device such as smartphone or tablet, and enables a payment to the entity prior to the end of the period of time. Automatically enabling the payment to the entity is performed prior to the end of the period of time. The entity can be one of a mortgage company, a bank, a utility company and a credit card company. The payment is given to the entity prior to the end of the period of time when the user does not interact with the interactive notice to enable payment. When the payment is automatically enabled to the entity, the payment is based on a determination of sufficient funds in the payment account. In one embodiment, the payment is automatically enabled utilizing the payment account and a separate account associated with the user.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an exemplary device notification screenshot;

FIG. 3 illustrates an exemplary interactive notice;

FIG. 4 illustrates an example fee prevention method embodiment; and

FIG. 5 illustrates an example fee prevention method embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The present disclosure addresses the need in the art for payment account fee prevention. A system, method and non-transitory computer-readable media are disclosed which prevents entities from applying penalty fees due to inactivity to payment accounts such as banking, credit card, mortgage and utility accounts. Users of payment accounts often have many different accounts, each having a varying number of fees and can easily become overburdened by tracking which actions do and do not trigger a fee application. A brief introductory description of a basic general purpose system or computing device in FIG. 1 which can be employed to practice the concepts is disclosed herein. A more detailed description of payment account fee prevention will then follow.

These variations shall be discussed herein as the various embodiments are set forth. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

Having disclosed some components of a computing system, the disclosure now turns to a discussion of payment account fee prevention. A system performing payment account fee prevention monitors purchases made by a user utilizing a payment account associated with an online store, the account having a penalty fee that is applied due to purchase inactivity during a period of time, to yield an analysis. For example, the online store may issue a fee for account inactivity over a period of time, such as a month. The fee prevention system can monitor the payment account associated with the online store so that a user is not charged a penalty fee. When the analysis indicates purchase account inactivity near the end of the period of time, the system withdraws an amount of money from the payment account prior to the end of the period of time. Account inactivity near the end of the period of time can be ten minutes for example, or another period of time such as two hours. For example, if a payment account associated with an online store receives a penalty fee when the account is unused within a 30 day window, the system can withdraw, an amount of money to the payment account such that the online store does not issue a penalty fee. The amount of money withdrawn in the online account example, is associated with a purchase using the payment account. The amount of money is refunded to the payment account after withdrawal when a user completes a purchase using the payment account within the period of time. For example, if the system withdraws $2 due to account inactivity ten minutes prior to the end of the period of time before a penalty fee is applied, and the user uses the account to purchase stamps five minutes prior to the end of the period of time, the system refunds the $2 to the account because the user completed a purchase before time ran out. The amount of money withdrawn can be calculated as a percentage of the penalty fee, or as a fixed amount. For example, the amount can be 40% of the penalty fee or a flat fee of $15 each time the system withdraws the money. The system can monitor the penalty fee for each payment account of a user and can change the amount of money withdrawn when the penalty fee changes. When the penalty fee for inactivity of an account associated with an online store increases from $4 to $4.50, the amount of money withdrawn can increase from a flat fee of $2 to $2.50.

In one embodiment, a user of a payment account is presented one or more advertisements on a user device. FIG. 2 illustrates an exemplary device notification screen shot on a user device 200. A user device is a device such as a smartphone or tablet, and can be any device capable of receiving a notification 202 pertaining to a payment account. The system performing fee prevention can send reminders electronically or in other ways to remind a user that a purchase has not been made within a predetermined time period. For example, the system can remind the user via email 204, text messaging 206 and/or via an application 208 loaded onto the device that the user has not performed the required function utilizing the payment account. For example, when the user does perform a purchase obligation within 30 days utilizing a payment account associated with an online store, the fee prevention system can provide a reminder that a fee will be applied or automatic purchase will be performed if the user does not act. A notification can simply be a statement reminding the user of the payment account and the obligation the user has, such as in an email or a text message or it can be more complex such as opening a fee prevention application on a smartphone. The fee prevention application can not only remind the user that a fee is due, but can show the user all payment accounts and fee status updates for each payment account. For example, a reminder using a smartphone application can provide a calendar of fees that will occur unless the user performs the required functions or can provide a history of applied fees for all of the user accounts. The application can provide an interface for performing the required functions.

A notification can include an advertisement for one or more products such that the user can purchase a product using the payment account to avoid incurring a penalty fee. The product can be selected based in part on the penalty fee and/or the type of payment account. The product can be based on an overstock of inventory or based on market research, user preferences, time of year (holidays, birthdays, anniversary, etc.), weather conditions, and so forth. Thus, the inventor of items that are purchased when a purchase needs to be made in this context can be more strategic and actually helpful to the user.

A notification that no activity has occurred using a particular credit card in 30 days is provided to the user's smartphone via an application loaded onto the phone. When the user views the notification, an advertisement for a hands-free device is displayed to the user, based on the penalty fee charged by the credit card company. The system can advertise a product having a cost less than, equal to or greater than the penalty fee. In some instances, it may make sense for the user to purchase an item and receive a product for less money than the cost of incurring a penalty fee. For example, when a user account is charged an inactivity related fee of $5, the fee prevention system can provide an advertisement for a product such as a high speed HDMI cable on sale for $2.64 with free shipping. In this case, it costs the user less money to purchase a product than have the penalty fee applied for account inactivity.

In another embodiment, the system monitors purchases made by a payment account of the user, such as a checking account, to determine whether a payment has been made during a period of time to an entity, such as a bank, the payment being associated with a periodic payment schedule to yield an analysis. For example, the fee prevention system can monitor mortgage payments from the user to the bank. When the analysis indicates a penalty fee application to the checking account due to an unpaid mortgage payment near the beginning of the month when the payment is due, the system can perform one or both of presenting an interactive notice and automatically enabling the payment. FIG. 3 illustrates an exemplary interactive notice on a user device 300. The device can receive an interactive notice such as an email, text message or via an application loaded onto the device. The interactive notice can enable the user to make a mortgage payment to the bank prior to the due date. For example, the interactive notice 300 informs the user that they have not paid their mortgage payment of $1,502 that is due the same day, and asks the user if they would like to make that payment or not 302. The user can choose to make the payment now, or to defer and risk having a late fee incurred. The interactive notice can be linked to the payment account and upon selecting “yes”, the system can automatically pay the mortgage for the user. The system of claim 12, wherein the computer-readable storage medium stores further instructions which result in the method further comprising charging the payment account a second penalty fee when the analysis indicates that no payment has been made and when the payment to the entity is made such that the penalty fee is not charged.

In another aspect, the system charges the payment account a second penalty fee when an analysis indicates that no payment has been made and when the payment to the entity is made such that the penalty fee is not charged. The second penalty fee may be less than the original penalty fee that would have been applied is the system had not stepped in an made a “purchase” to avoid the original penalty fee.

In one embodiment, if the user does not respond to the interactive notice, the system can automatically enable the payment from the checking account to the mortgage company such that the user does not make a late payment. The system can automatically enable the mortgage payment to the bank prior to the due date. The automatic payment is dependent on determining that there are sufficient funds in the payment account to cover the cost of the payment, such as a mortgage payment. When there are insufficient funds to cover the cost of the payment, or for another reason, the system can utilize the payment account and another account associated with the user to make a payment to an entity. For example, the payment account and another account such as a savings account can be used to make the mortgage payment.

The interactive notice presented to the user can include one or more advertisements. For example, a notice can include advertisements related to loans offered by a bank 304. The advertisements can be based on the type of payment account, for example, a mortgage account and can be based on other factors such as shopping history and user preferences. The system can link the interactive notice with an on-line shopping account such as Amazon storing user preferences and shopping history such that the system can advertise appropriately.

Having disclosed some basic system components and concepts, the disclosure now turns to the exemplary method embodiment shown in FIG. 4. For the sake of clarity, the method is discussed in terms of an exemplary system 100 as shown in FIG. 1 configured to practice the method. The steps outlined herein are exemplary and can be implemented in any combination thereof, including combinations that exclude, add, or modify certain steps.

FIG. 4 illustrates an exemplary fee prevention method embodiment. A system implementing the method monitors purchases made by a payment account having a penalty fee that is applied due to purchase inactivity to yield an analysis (402). The system withdraws an amount of money from the payment account when the analysis indicates purchase inactivity (404). The withdrawal may be more than just a withdrawal. For example, the system could have a rotating set of inexpensive products that are actually purchased. Some systems may not apply a simple withdrawal as a transaction that counts to avoid the fee. Thus, this system can initiate a purchase of a small item that could even be automatically shipped to the user so as to avoid the payment of an inactivity fee or a fee due to some lack of meeting a threshold in use of the payment account.

FIG. 5 illustrates an exemplary fee prevention method embodiment. A system monitors purchases made by a payment account to yield an analysis (502). When the system determines that there is purchase inactivity relating to the payment account (504), the system presents an interactive notice to a user device enabling a payment to an entity prior to the end of a period of time (506). Then the system automatically enables the payment to the entity prior to the end of the period of time (508). When the system determines that there is not purchase inactivity, such as when the account has been active, the process is complete.

In one aspect, a fees service could have an algorithm that analyzes a particular payment account to evaluate what kind of detection, monitoring and payment services are provided. For example, if the various payment accounts fall into three categories (such as a one month of inactivity=fees; dropping the account below a dollar amount=fees, and purchases under $15 for the month=fees), the system could evaluate one or more payment accounts and determine what kind of service is needed for each respective account for the account holder to avoid fees. Then the system could report to the account holder and via approval of the account holder, the system could then implement a policy to monitor the account and make “purchases” (which may differ just from debits, which the account may not allow), or other transactions that cost the account holder a transaction fee (optionally) and saves the money that would have otherwise been charged.

The account analysis and monitoring system could also apply to such things as insurance accounts. If an account like a car insurance account or a health insurance account is dropped, it can be very expensive to start up again. Therefore, a system could also monitor such accounts and make sure that such policies don't lapse by making automatic payments or notifications to the user. This would avoid any reactivation fees.

The system could also monitor services during a free trial window. For example, often users can get a 1 month free subscription to a movie channel or internet service, etc. After the free service, in which it is usually difficult to identify exactly how to cancel the service, the service automatically turns into a fee based service with a high monthly fee. The system disclosed herein could be enabled to monitor such accounts and cancel those accounts or take other transaction actions to avoid the increase in fees. The service could also monitor such accounts as cellular accounts where a renegotiation window exists or is created in which the user should reestablish a contract or jump at an opportunity to get a better deal or to reduce fees. The system could evaluate the deals, and the timing of offers for the account and summarize in a user interface the options for the user to choose. Then the system could receive instructions from the user via the interface to accept or renegotiate a deal and the system could then carry out the renegotiation or the altered account status.

In another aspect, the system presents the user with a fee optimizer approach in which the various fees of various accounts are analyzed and the system enables the user to utilize the cheapest accounts based on their purchasing history, instructions, and so forth. Overages on accounts could be monitored to avoid extra fees charged when a bank, for example, honors a purchase and the user does not have sufficient funds. By monitoring the account activity, the system can notify the user of the account balance and the likely fee that will come. If there is a reoccurring fee problem, the system could give notice to cancel a service or an account.

Embodiments within the scope of the present disclosure may also include tangible and/or non-transitory computer-readable storage media or a computer readable device for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media or computer-readable storage devices can include RAM, ROM, EEPROM, CD-ROM or other optical disk storage, magnetic disk storage or other magnetic storage devices, or any other structure which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply to any system charging penalty fees. Those skilled in the art will readily recognize various modifications and changes that may be made to the principles described herein without following the example embodiments and applications illustrated and described herein, and without departing from the spirit and scope of the disclosure.

We claim:

1. A method comprising:
monitoring, via a processor, purchases made by a payment account, the payment account having a penalty fee that is applied due to purchase inactivity during a period of time, to yield an analysis; and
when the analysis indicates payment account purchase inactivity near an end of the period of time, withdrawing an amount of money from the payment account prior to the end of the period of time.

2. The method of claim 1, wherein the period of time is one month.

3. The method of claim 1, wherein the purchase inactivity near an end of the period of time comprises ten minutes prior to the end of the period of time.

4. The method of claim 1, wherein withdrawing the amount of money from the payment account prevents application of the penalty fee because the withdrawing is associated with a purchase using the payment account.

5. The method of claim 1, wherein the amount of money is refunded to the payment account after withdrawal when a user completes a purchase using the payment account within the period of time.

6. The method of claim 1, wherein the amount of money is calculated as a percentage of the penalty fee.

7. The method of claim 1, wherein the amount of money is fixed.

8. The method of claim 1, further comprising monitoring a penalty fee amount and calculating the amount of money based on the penalty fee amount.

9. The method of claim 1, further comprising presenting an advertisement to a user device of a user of the payment account that is based on payment account purchase inactivity and the end of the time period, such that when the user makes a purchase based on the advertisement, the amount of money is withdrawn from the payment account and a product associated with the advertisement is delivered to the user.

10. The method of claim 9, wherein the product is selected based at least in part on the penalty fee.

11. The method of claim 9, wherein the product is selected based at least in part on a type of payment account.

12. A system comprising:
a processor; and
a computer-readable storage medium storing instructions which, when executed on the processor, perform a method comprising:
monitoring, via a processor, purchases made by a payment account of a user to determine whether a payment has been made during a period of time to an entity, the payment being associated with a periodic payment schedule, to yield an analysis; and
when the analysis indicates that a penalty fee will be applied to the payment account due to payment account purchase inactivity near an end of the period of time, performing at least one of the following according to a policy:
presenting an interactive notice to a user device of the user, the interactive notice enabling a payment to the entity prior to the end of the period of time; and
automatically enabling the payment to the entity prior to the end of the period of time.

13. The system of claim 12, wherein the entity is one of a mortgage company, a bank, a utility company, and a credit card company.

14. The system of claim 12, wherein the computer-readable storage medium stores further instructions which result in the method further comprising charging the payment account a second penalty fee when the analysis indicates that no payment has been made and when the payment to the entity is made such that the penalty fee is not charged.

15. The system of claim 12, wherein payment is given to the entity prior to the end of the period of time when the user does not interact with the interactive notice to enable payment to the entity from the payment account prior to the end of the period of time.

16. The system of claim 12, wherein automatically enabling the payment to the entity prior to the end of the period of time further comprises utilizing at least one of the payment account and a separate account associated with the user.

17. The system of claim 12, wherein automatically enabling the payment to the entity is based on a determination of sufficient funds in the payment account.

18. A computer-readable storage medium storing instructions which, when executed by a computing device, cause the computing device perform operations comprising:
monitoring, via a processor, purchases made by a payment account, the payment account having a penalty fee that is applied due to purchase inactivity during a period of time, to yield an analysis; and
when the analysis indicates payment account purchase inactivity near an end of the period of time, withdrawing an amount of money from the payment account prior to the end of the period of time.

19. The computer-readable storage medium of claim 18, wherein withdrawing the amount of money from the payment account prevents application of the penalty fee because the withdrawing is associated with a purchase using the payment account.

20. The computer-readable storage medium of claim 18, further comprising monitoring a penalty fee amount and calculating the amount of money based on the penalty fee amount.
